(19) United States
(12) Patent Application Publication
(10) Pub. No.: US 2024/0353114 A1
(43) Pub. Date: Oct. 24, 2024

(54) COOKING APPLIANCE INCLUDING MULTIPLE HEATING ZONES

(71) Applicant: Haier US Appliance Solutions, Inc., Wilmington, DE (US)

(72) Inventor: Eric Scott Johnson, Louisville, KY (US)

(21) Appl. No.: 18/302,437

(22) Filed: Apr. 18, 2023

(51) Int. Cl. F24C 15/32; A23L 5/10; F24C 7/08

(52) U.S. Cl. CPC F24C 15/325; A23L 5/15; F24C 7/085; F24C 7/067; G06V 20/50

(57) ABSTRACT

A method of operating a cooking appliance is provided. The cooking appliance includes a cooking chamber defining a plurality of cooking zones, a duct system in fluid communication with the cooking chamber and a convection fan. The method includes receiving a first temperature request for a first cooking zone of the plurality of cooking zones; receiving a second temperature request for a second cooking zone of the plurality of cooking zones; determining an operational parameter of the convection fan based on the first temperature request, the first cooking zone, the second temperature request, and the second cooking zone; and directing the convection fan according to the determined operational parameter. The operational parameter of the convection fan includes at least one of a rotation direction, a duty cycle, or a rotation speed.

### FIELD OF THE INVENTION

The present subject matter relates generally to cooking appliances, and more particularly to multi-zone oven appliances and methods for operating the same.

### BACKGROUND OF THE INVENTION

Oven appliances generally include a cabinet that defines a cooking chamber for cooking food items therein, such as by baking or broiling the food items. In order to perform the cooking operation, oven appliances typically include one or more heat sources, or heating elements, provided in various locations within the cooking chamber. These heat sources may be used together or individually to perform various specific cooking operations, such as baking, broiling, roasting, and the like.

Some oven appliances may be able to perform cooking operations on multiple food items simultaneously by allocating zones within the cooking chamber. However, current oven appliances are not able to determine, or may only approximate different cooking times or power levels of different food items placed in the cooking chamber. Accordingly, the cooking operations on multiple food items may lead to undercooked or overcooked foods, depending on what is being cooked, the state at which it is placed in the cooking chamber, and the accuracy of the cooking algorithms.

Accordingly, a method of operating a cooking appliance that obviates one or more of these drawbacks would be beneficial. Particularly, a method of operating an oven appliance that is able to account for multiple temperature zones or cooking parameters would be desirable.

### BRIEF DESCRIPTION OF THE INVENTION

Aspects and advantages of the invention will be set forth in part in the following description, or may be obvious from the description, or may be learned through practice of the invention.

In one exemplary aspect of the present disclosure, a cooking appliance is provided. The cooking appliance may include a cabinet forming a cooking chamber, the cooking chamber defining a plurality of cooking zones therein; a plurality of heating elements provided within the cooking chamber; a duct system in fluid communication with the cooking chamber, the duct system defining an intake and at least one exhaust outlet; a convection fan for motivating air between the cooking chamber and the duct system; and a controller operably connected with the plurality of heating elements and the convection fan, the controller configured to perform a cooking operation. The cooking operation may include receiving a first temperature request for a first cooking zone of the plurality of cooking zones; receiving a second temperature request for a second cooking zone of the plurality of cooking zones; determining an operational parameter of the convection fan based on the first temperature request, the first cooking zone, the second temperature request, and the second cooking zone; and directing the convection fan according to the determined operational parameter, wherein the operational parameter of the convection fan includes at least one of a rotation direction, a duty cycle, or a rotation speed.

In another exemplary aspect of the present disclosure, a method of operating a cooking appliance is provided. The cooking appliance may include a cooking chamber defining a plurality of cooking zones, a plurality of heating elements, a duct system in fluid communication with the cooking chamber and defining an intake and at least one exhaust outlet, and a convection fan for motivating air between the cooking chamber and the duct system. The method may include receiving a first temperature request for a first cooking zone of the plurality of cooking zones; receiving a second temperature request for a second cooking zone of the plurality of cooking zones; determining an operational parameter of the convection fan based on the first temperature request, the first cooking zone, the second temperature request, and the second cooking zone; and directing the convection fan according to the determined operational parameter, wherein the operational parameter of the convection fan includes at least one of a rotation direction, a duty cycle, or a rotation speed.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front view of an exemplary cooking appliance with the door in a closed position according to exemplary embodiments of the present disclosure.

FIG. 2 provides a schematic side view representation of the cooking appliance of FIG. 1 illustrating multiple zones within a cooking chamber.

FIG. 3 provides a schematic top view representation of the cooking appliance of FIG. 1 illustrating multiple zones within the cooking chamber.

FIG. 4 provides a schematic side view representation of the cooking appliance of FIG. 1 illustrating multiple zones within the cooking chamber.

FIG. 5 provides a schematic side view representation of the cooking appliance of FIG. 1 illustrating multiple cookware items within the cooking chamber.

FIG. 6 provides a schematic front view representation of the cooking appliance of FIG. 1 illustrating a convection fan.

FIG. 7 provides a schematic representation of a display of the exemplary cooking appliance of FIG. 1.

FIG. 8 provides a flow chart illustrating a method of operating a cooking appliance according to exemplary embodiments of the present disclosure.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

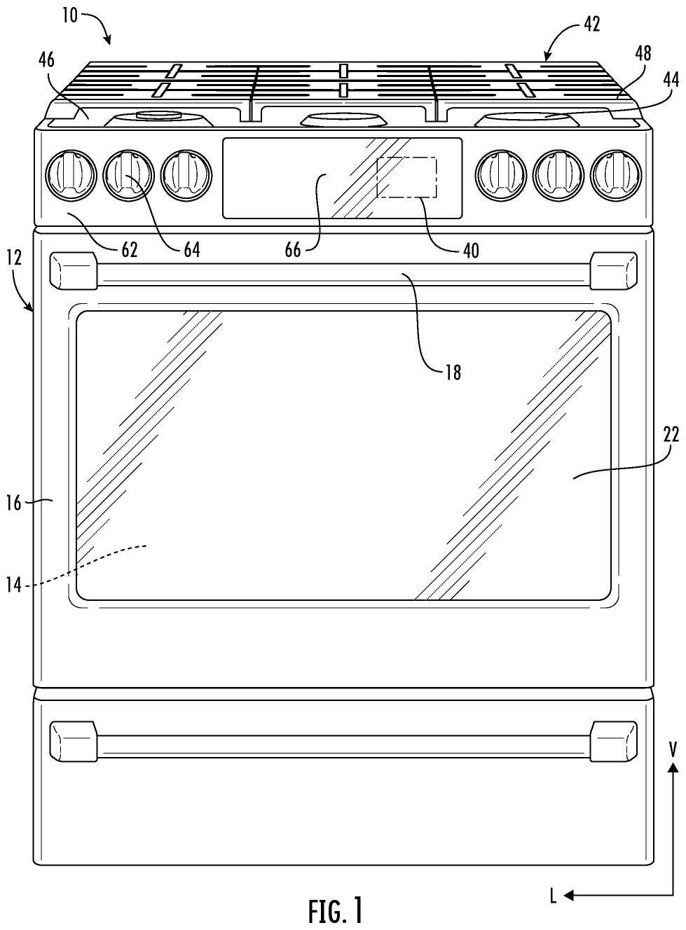

Turning now to the figures, FIG. 1 provides a perspective view of a cooking appliance 10 according to exemplary embodiments of the present disclosure. Generally, cooking appliance 10 defines a vertical direction V, a lateral direction L, and a transverse direction T. The vertical direction V, lateral direction L, and transverse direction T are mutually perpendicular and form an orthogonal direction system. As will be understood, cooking appliance 10 is provided by way of example only, and the present subject matter may be used in any suitable appliance. Thus, the present disclosure may be used with other oven, range, or countertop appliance configurations (e.g., configurations that define multiple interior cavities for the receipt of food or are otherwise different than the configuration shown in FIG. 1), as well as other suitable appliances, as would be understood in light of the present disclosure.

Cooking appliance 10 may include an insulated cabinet 12 with an interior cooking chamber 14 defined by an interior surface of cabinet 12. Cooking chamber 14 is configured for the receipt of one or more food items to be cooked. Cooking appliance 10 includes a door 16 rotatably mounted to cabinet 12 (e.g., with a hinge—not shown). A handle 18 may be mounted to door 16 and may assist a user with opening and closing door 16 in order to access an opening to cooking chamber 14. For example, a user can pull on handle 18 to open or close door 16 and access cooking chamber 14 through the opening. As will be described below, one or more internal heating elements (e.g., baking, broiling, or convection heating elements) may be provided within cooking chamber 14 to cook or otherwise heat items therein.

Cooking appliance 10 may include a seal (not shown) between door 16 and cabinet 12 that assist with maintaining heat and cooking fumes within cooking chamber 14 when door 16 is closed, as shown in FIG. 1. One or more parallel glass panes 22 provide for viewing the contents of cooking chamber 14 when door 16 is closed and assist with insulating cooking chamber 14. Optionally, one or more baking racks may be positioned in cooking chamber 14 for the receipt of food items or utensils containing food items.

Cooking appliance 10 may include a cooktop surface 42 having one or more heating elements 44 for use in heating or cooking operations. In exemplary embodiments, cooktop surface 42 is comprised of a metal (e.g., steel) panel 46 on which one or more grates 48 may be supported. In other embodiments, however, cooktop surface 42 may be comprised of another suitable material, such as a ceramic glass or another suitable non-metallic material. Heating elements 44 may be various sizes, as shown in FIG. 1, and may employ any suitable method for heating or cooking an object, such as a cooking utensil (not shown), and its contents. In one embodiment, for example, heating element uses a heat transfer method, such as electric coils or gas burners, to heat the cooking utensil. In another embodiment, however, heating element 44 uses an induction heating method to heat the cooking utensil directly. In turn, heating element may include a burner element, electric heat element, induction element, or another suitable heating element.

Some embodiments of cooking appliance 10 include a controller 40 (e.g., configured to control one or more operations of cooking appliance 10). For example, controller 40 may control at least one operation of cooking appliance 10 that includes an internal heating element or cooktop heating element 44. Controller 40 may be in communication (via for example a suitable wired or wireless connection) with one or more of heating element(s) 44 and other suitable components of cooking appliance 10, as discussed herein. In general, controller 40 may be operable to configure cooking appliance 10 (and various components thereof) for cooking. Such configuration may be based, for instance, on a plurality of cooking factors of a selected operating cycle or mode.

By way of example, controller 40 may include one or more memory devices and one or more microprocessors, such as general or special purpose microprocessors operable to execute programming instructions or micro-control code associated with an operating cycle. The memory may represent random access memory such as DRAM, or read only memory such as ROM or FLASH. In one embodiment, the processor executes programming instructions stored in memory. The memory may be a separate component from the processor or may be included onboard within the processor.

Controller 40 may be positioned in a variety of locations throughout cooking appliance 10. As illustrated, controller 40 may be located within a user interface 62 of cooking appliance 10. In some such embodiments, input/output (“I/O”) signals may be routed between controller 40 and various operational components of cooking appliance 10, such as heating element(s) 44, control knobs 64, display component 66, sensors, alarms, or other components as may be provided. For instance, signals may be directed along one or more wiring harnesses that may be routed through cabinet 12. In some embodiments, controller 40 is in communication with user interface assembly 62 and control knobs 64 through which a user may select various operational features and modes and monitor progress of cooking appliance 10. In one embodiment, user interface assembly 62 may represent a general purpose I/O (“GPIO”) device or functional block. In one embodiment, user interface assembly 62 may include input components, such as one or more of a variety of electrical, mechanical, or electro-mechanical input devices including rotary dials, push buttons, and touch pads. User interface assembly 62 may include a display component 66, such as a digital or analog display configured to provide operational feedback to a user.

While cooking appliance 10 is shown as a cooktop oven combination, the present invention could also be used with other cooking appliances such as, e.g., a stand-alone oven, an oven with a stove-top, or other configurations of such ovens. Numerous variations in the oven configuration are possible within the scope of the present subject matter. For example, variations in the type and/or layout of the user interface assembly 62, as mentioned above, are possible. As another example, cooking appliance 10 may include multiple doors 16 instead of or in addition to the single door 16 illustrated. Such examples include a dual cavity oven, a French door oven, and others. The examples described herein are provided by way of illustration only and without limitation.

User interface assembly 62 (e.g., display 66) may include one or more touch controls. For instance, display 66 may be a touch display (e.g., capacitive touch, proximity touch, pressure switch, etc.) capable of receiving touch inputs from a user relating to cooking operations. Additionally or alternatively, user interface assembly 62 may include one or more additional touch controls separate from display 66 that are capable of receiving touch inputs to control cooking appliance 10. User selections may then be displayed on display 66 to provide visual confirmation to the user of selections made. For instance, multiple selections may be made before initiating a particular cooking operation, as will be described in more detail below.

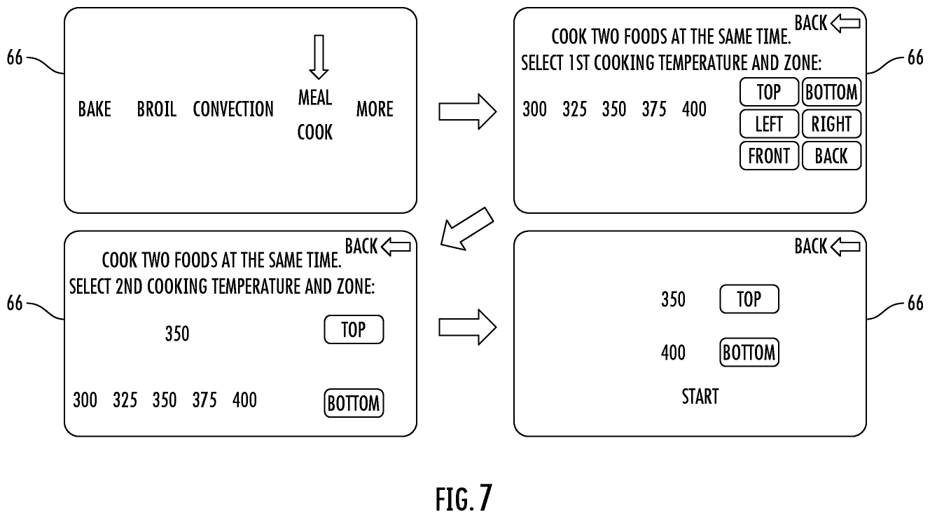

According to some embodiments, cooking appliance 10 (e.g., within cooking chamber 14) is capable of cooking multiple items at different temperatures within cooking chamber 14. In detail, the cooking operation may receive a plurality of inputs (e.g., user inputs) relating to a plurality of cooking zones (described below) within cooking chamber 14. Accordingly, user interface assembly 62 may prompt a user to select a cooking mode to initiate the specified cooking operation. As shown in FIG. 7, display 66 may display a plurality of potential cooking modes for the user to select.

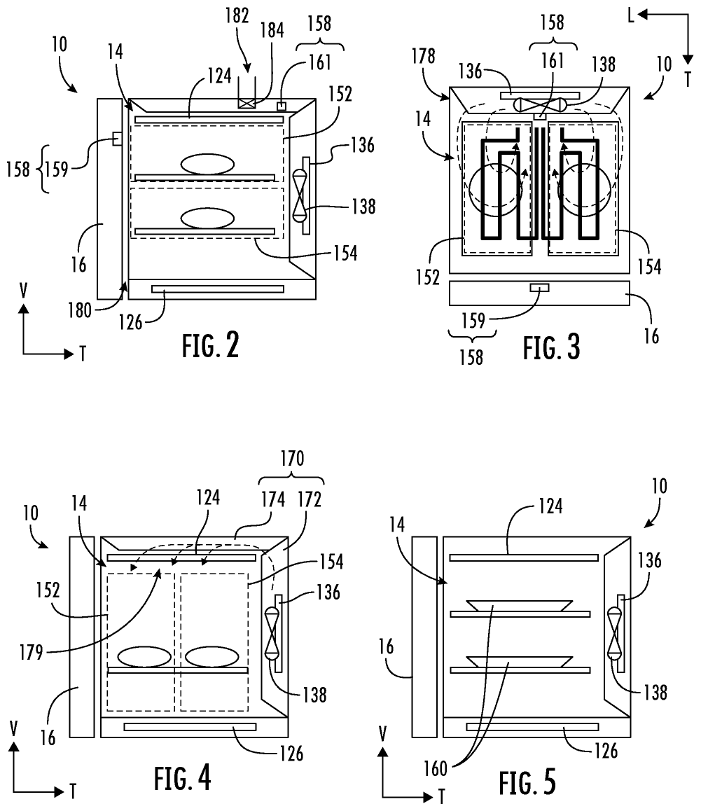

Referring now to FIGS. 2 through 5, various schematic representations of cooking chamber 14 are provided. As shown in FIG. 2, cooking chamber 14 may be divided into several distinct heating zones. For instance, cooking chamber 14 may include a first heating zone, or zone 1 152, and a second heating zone, or zone 2 154. It should be understood that any suitable number of heating zones may be incorporated into cooking chamber 14, including more than two heating zones. Each of the heating zones may be spaced apart from one another (e.g., along the vertical direction V, the lateral direction L, and/or transverse direction T). In other words, zone 1 152 may be spaced apart from zone 2 154, etc. Accordingly, each heating zone may be controlled separately from one another (e.g., to or at a different temperature or power level, using a different criterion, or using a different heating cycle).

Further, one or more heating elements may be provided at the top, bottom, or both of cooking chamber 14, and may provide heat to cooking chamber 14 for cooking. Such heating element(s) can be gas, electric, microwave, or a combination thereof. For example, in the embodiment shown in FIG. 2, cooking appliance 10 includes a top heating element 124 positioned at a top of cooking chamber 14 and a bottom heating element 126 positioned at a bottom of cooking chamber 14. Other configurations may be used as well. For instance, multiple top heating elements 124 and multiple bottom heating elements 126 may be incorporated.

Cooking appliance 10 may also have a convection heating element 136 and/or convection fan 138 (e.g., collectively a convection heating assembly) positioned adjacent a back wall 116 of cooking chamber 14. Convection fan 138 may be powered by a convection fan motor. Further, convection fan 138 may be a variable speed fan-meaning the speed of fan 138 may be controlled or set anywhere between and including, e.g., zero and one hundred percent (0%-100%). According to at least one example, convection fan 138 is provided as a stand-alone fan (e.g., without an accompanying convection heating element). In certain embodiments, cooking appliance 10 also includes a bidirectional triode thyristor (not shown), i.e., a triode for alternating current (TRIAC), to regulate the operation of convection fan 138 such that the speed of fan 138 may be adjusted during operation of cooking appliance 10. The speed of convection fan 138 may be determined by controller 40. In addition, a sensor such as, e.g., a rotary encoder, a Hall effect sensor, or the like, may be included at the base of fan 138 to sense the speed of fan 138.

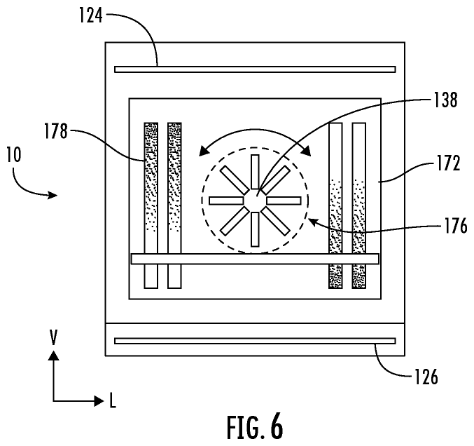

The speed of fan 138 may be measured in, e.g., revolutions per minute (“RPM”). In some embodiments, the convection fan 138 may be configured to rotate in two directions, e.g., a first direction of rotation and a second direction of rotation opposing the first direction of rotation (see FIG. 6). For example, in some embodiments, reversing the direction of rotation, e.g., from the first direction to the second direction or vice versa, may still direct air from the back of cooking chamber 14. As another example, in some embodiments reversing the direction results in air being directed from the top and/or sides of cooking chamber 14 rather than the back of cooking chamber 14. Additionally or alternatively, an effective speed for convection fan 138 may be determined. The effective speed of fan 138 may include adjusting a rotational speed of the fan. Moreover, the effective speed may relate to a duty cycle of fan 138. For instance, an effective speed of fan 138 may incorporate a determined cycle of “ON” and “OFF” times (e.g., in addition to or apart from the rotational speed).

In various embodiments, more than one convection heater assembly, e.g., more than one convection heating element 136 and/or convection fan 138 may be provided. In such embodiments, the number of convection fans and convection heaters may be the same or may differ, e.g., more than one convection heating element 136 may be associated with a single convection fan 138. Similarly, top heating elements and/or bottom heating elements may be provided in various combinations, e.g., one top heating element with two or more bottom heating elements, two or more top heating elements 124, 126 with no bottom heating element, etc.

Cooking appliance 10 may include a cooking chamber vent or vent passageway. In detail, an ambient air inlet 180 may be defined within (or through) cabinet 12 of cooking appliance 10. Ambient air inlet 180 may be provided between door 16 and cooking chamber 14, for instance. According to at least some embodiments, ambient air inlet 180 is provided at or near a bottom of cabinet 12 (e.g., along the vertical direction V). Additionally or alternatively, ambient air inlet 180 may be provided naturally (e.g., through a gasket provided between door 16 and cabinet 12). Ambient atmospheric air (e.g., ambient air from a room in which cooking appliance 10 is provided) may selectively enter cooking chamber 14 via ambient air inlet 180. In some instances, a pressure difference between cooking chamber 14 and the ambient atmosphere may draw the ambient atmospheric air into cooking chamber 14. Additionally or alternatively, a door, flap, gate, skirt, or other movable physical element may be provided at ambient air inlet 180. Thus, ambient air inlet 180 may be selectively opened or closed according to an input (e.g., to a connected motor, for instance).

Cooking appliance 10 may further include a cooking chamber vent 182. Cooking chamber vent 182 may be defined within (or through) cabinet 12. For instance, cooking chamber vent 182 provides fluid communication between cooking chamber 14 and the ambient atmosphere. Heated air within cooking chamber 14 may be selectively discharged or vented to the ambient atmosphere via cooking chamber vent 182. For instance, cooking chamber vent passageway may be defined between ambient air inlet 180 and cooking chamber vent 182. Thus, ambient air (e.g., cooling air) may be cycled or urged from ambient air inlet 180 to cooking chamber vent 182 (e.g., through cooking chamber 14) to provide selective cooling to cooking chamber 14 or items (e.g., food items) provided therein. Additionally or alternatively, a door, flap, gate, skirt, or other movable physical element may be provided at cooking chamber vent 182. Thus, cooking chamber vent 182 may be selectively opened or closed according to an input (e.g., to a connected motor, for instance).

Cooking appliance 100 may include a cooling fan 184. Cooling fan 184 may be provided at or near cooking chamber vent 182. In at least some embodiments, cooling fan 184 is provided at a downstream end of cooking chamber vent 182 (e.g., an exhaust side). For instance, cooling fan 184 may be an axial fan provided along the cooking chamber vent passageway to selectively urge the air within cooking chamber 14 (e.g., air provided to cooking chamber 14 via ambient air inlet 180). Accordingly, cooling fan 184 may be in fluid communication with cooking chamber 14. Cooling fan 184 may be selectively activated to produce a venting phenomenon according to one or more inputs (e.g., manual inputs via user interface 62, automatic inputs related to a cooking chamber temperature against a temperature input, etc.).

Additionally or alternatively, cooling fan 184 may be a variable speed air handler capable of operating at a plurality of rotational speeds, as would be understood. For instance, cooling fan 184 may include a high speed setting and a low speed setting (among additional speed settings). The high speed setting may produce a first flow path of the cooking chamber vent passageway while the low speed setting may produce a second flow path of the cooking chamber vent passageway. Thus, the operational speed of cooling fan 184 may be selected according to the first temperature and first heating zone 152 (or second temperature and second heating zone 154). For instance, the operational speed of cooling fan 184 may be adjusted according to which heating zone requests the lower temperature.

As shown in FIG. 2, zone 1 152 may be defined within an upper half of cooking chamber 14 (e.g., along the vertical direction V) and zone 2 154 may be defined within a lower half of cooking chamber 14 (e.g., along the vertical direction V, beneath zone 1 152). In detail, zone 1 152 may encompass an entire upper half of cooking chamber 14 while zone 2 154 encompasses an entire lower half of cooking chamber 14. Each of zone 1 152 and zone 2 154 may be at least partially defined by one or more racks, for instance (e.g., provided along the lateral direction L and transverse direction T). Accordingly, a first cooking item (e.g., food item, cookware item, baking item, etc.) may be positioned within zone 1 152 while a second cooking item is positioned within zone 2 154. It should be noted that each of zone 1 152 and zone 2 154 may receive heat or be affected by each active heating element within cooking chamber 14.

Similarly, with reference to FIG. 3, zone 1 152 may be defined within a first lateral side of cooking chamber 14 (e.g., a left side) and zone 2 154 may be defined within a second lateral side of cooking chamber 14 (e.g., a right side). According to this example, zone 1 152 encompasses an entire first lateral side of cooking chamber 14 (e.g., from a lateral midpoint of cooking chamber 14 to an inner wall of cooking chamber 14, from a top wall to a bottom wall, and from a back wall to door 16), while zone 2 154 encompasses an entire second lateral side of cooking chamber 14. For yet another example, with reference to FIG. 4, zone 1 152 may be defined within a front portion of cooking chamber 14 while zone 2 154 may be defined within a rear portion of cooking chamber 14. Thus, zone 1 152 may encompass an entire front half of cooking chamber 14 (e.g., from a transverse midpoint of cooking chamber 14 to door 16, from the top wall to the bottom wall, and from the first lateral side to the second lateral side) while zone 2 154 encompasses an entire rear half of cooking chamber 14. Additionally or alternatively, each of the plurality of cooking zones defined within cooking chamber 14 may be arbitrarily defined or selected by a user when initiating a joint cooking operation. For instance, the user may have an option to select an upper zone, a lower zone, a left zone, a right zone, a front zone, a back zone, a central zone, or the like.

FIG. 5 provides an exemplary schematic view of cooking chamber 14 containing several cookware items. As shown, the cooking items provided within cooking chamber 14 (e.g., within each of first heating zone 152 and second heating zone 154) may have a predetermined size. For instance, each cookware item may occupy a certain percentage of the cooking rack on which they are supported. This in turn may affect an amount of heat (e.g., heat energy) is absorbed by the cookware item and transferred to the contents of the cookware item. Additionally or alternatively, each cookware item may have a unique finish exhibiting a number of specific attributes (e.g., color, reflectivity, texture, shade, etc.). For at least one example, cookware with a lighter color or shade (e.g., silver, white, mirrored, etc.) may reflect more heat or thermal energy (e.g., toward other cooking zones) and absorb less heat or thermal energy. Accordingly, cookware with a darker color or shade (e.g., black, brown, matte, etc.) may absorb more heat or thermal energy. As will be described below, certain operations may be adjusted according to the cookware attributes.

One or more sensors 158 may be provided within cooking chamber 14. The one or more sensors 158 may include, for instance, a camera 159. However, the one or more sensors 158 may include, in addition to or alternatively from the camera, an ultrasonic sensor, an infrared sensor, an optical sensor, or the like. Hereinafter, the one or more sensors 158 will be described with specific reference to a camera (e.g., camera 159). It should be understood that the information or data collected by camera 159 may be obtained through any suitable sensor, such as the aforementioned ultrasonic sensor or optical sensor.

Generally, camera 159 may be a video camera or a digital camera with an electronic image sensor [e.g., a charge coupled device (CCD) or a CMOS sensor]. When assembled, camera 159 is in communication (e.g., electric or wireless communication) with controller 40 such that controller 40 may receive a signal from camera 159 corresponding to the image captured by camera 159. Camera 159 may be configured to capture images of cooking chamber 14 (e.g., each of the plurality of cooking zones). For instance, camera 159 may capture images of food items placed in each of first heating zone 152, second heating zone 154, a third heating zone, or any additional heating zones. Camera 159 may be located in any suitable location within cooking chamber 14, such that each of first heating zone 152 and second heating zone 154 are visible to camera 159. For example, camera 159 may be located at or near a top of cooking chamber 14 along the vertical direction V. Additionally or alternatively, camera 159 may be located at or near a center of cooking chamber 14 along the lateral direction L. The specific location of camera 159 is not limited, however, and one of ordinary skill in the art would appreciate multiple potential locations for camera 159.

The image or images captured by camera 159 may be analyzed (e.g., within controller 40) to determine one or more attributes of a cookware item 160 within cooking chamber 14. For instance, camera 159 may capture an image of cookware item 160 (e.g., roasting pan, baking dish, cookie sheet, etc.) within first heating zone 152. The image may be analyzed to determine certain features of cookware item 160. For instance, the analysis may determine a material, an emissivity, a surface texture, a color, a size, a shape, or the like of the cookware item. Such features may selectively alter a heating rate of the items (e.g., food items) within cooking chamber 14. For instance, the attributes of cookware item 160 may affect thermal energy transfer of each of a first food item provided within first heating zone 152 and a second food item provided within second heating zone 154.

The one or more sensors may additionally include a temperature sensor 161. For instance, a single temperature sensor 161 may be provided within cooking chamber 14. Temperature sensor 161 may be positioned, for example, on a back wall, upper wall, or side wall of cooking chamber 14. Temperature sensor 161 may sense (e.g., selectively, continuously) a temperature within cooking chamber 14 (e.g., at predetermined intervals). Additionally or alternatively, temperature sensor 161 may transmit the sensed temperatures to controller 40.

As used herein, “temperature sensor” or the equivalent is intended to refer to any suitable type of temperature measuring system or device positioned at any suitable location for measuring the desired temperature. Thus, for example, the temperature sensor may be any suitable type of temperature sensor, such as a thermistor, a thermocouple, a resistance temperature detector, a semiconductor-based integrated circuit temperature sensors, etc. In addition, the temperature sensor may be positioned at any suitable location and may output a signal, such as a voltage, to a controller that is proportional to and/or indicative of the temperature being measured. Although exemplary positioning of temperature sensors is described herein, it should be appreciated that appliance 10 may include any other suitable number, type, and position of temperature, humidity, and/or other sensors according to alternative embodiments.

FIG. 6 provides a front schematic view of cooking chamber 14, specifically convection fan 138. In detail, cooking appliance 10 may include a duct system 170. Duct system 170 may be in fluid communication with cooking chamber 14. For instance, duct system 170 may be provided within cabinet 12 adjacent to cooking chamber 14. Duct system 170 may define a passageway through which convection air (e.g., as motivated by convection fan 138) flows. Accordingly, air or heated air within cooking chamber 14 may be routinely or continuously cycled through cooking chamber 14 to perform a convection style heating or cooking operation.

Duct system 170 may include a rear duct 172 and a top duct 174. Rear duct 172 may be provided at a rear of cabinet 12 (e.g., along the transverse direction T). For instance, rear duct 172 may define a height (along the vertical direction V) and a width (along the lateral direction L) that is substantially similar to a height and width of cooking chamber 14. In some embodiments, the height and width of rear duct 172 are between about 5% and about 20% smaller than the height and width of cooking chamber 14. Accordingly, the air circulated by convection fan 138 may be discharged from rear duct at or near peripheral edges of rear duct 172 (e.g., lateral edges, a top edge, etc.).

Convection heating assembly (e.g., convection heating element 136 and/or convection fan 138) may be provided within rear duct 172. As shown in FIG. 6, for instance, convection fan 138 may be located at or near a center (e.g., along the lateral direction L and vertical direction V) of rear duct 172. In some embodiments, convection fan 138 is provided closer to a bottom of rear duct 172 (e.g., along the vertical direction V). Additionally or alternatively, as mentioned above, convection fan 138 may be provided as a stand-alone circulation fan within rear duct 172 (e.g., omitting convection heating element 136).

Duct system 170 may define an intake 176 through which air from cooking chamber 14 is supplied to convection fan 138. In detail, intake 176 may be defined in rear duct 172. Intake 176 may be formed as an opening or series of openings (e.g., louvers) within rear duct 172. For instance, intake 176 may be defined such that an axial flow of air from cooking chamber 14 is provided along the transverse direction T (e.g., from front to back). Accordingly, air from cooking chamber 14 may be suctioned along the transverse direction T from cooking chamber 14 into rear duct 172.

Duct system 172 may include or define at least one exhaust outlet. In detail, the at least one exhaust outlet may include a pair of side exhaust outlets 178. Referring briefly to FIG. 3, the pair of side exhaust outlets 178 may be defined at lateral edges (or sides) of rear duct 172. Accordingly, convection air (e.g., as circulated by convection fan 138) may be motivated into cooking chamber 14 via one or both of the pair of side exhaust outlets 178. Additionally or alternatively, each of the pair of side exhaust outlets 178 may extend along the vertical direction V. For instance, each of the pair of side exhaust outlets 178 may include one or more openings or louvers extending predominantly along the vertical direction V. An extending length of each of the pair of side exhaust outlets 178 may vary according to specific embodiments. For one example, the openings or louvers of the side exhaust outlets 178 extend between about 60% and about 80% of a total height (e.g., along the vertical direction V) of rear duct 172.

Top duct 174 may be fluidly connected with rear duct 172. For instance, top duct 174 may be integrally formed with rear duct 172. Thus, air motivated by convection fan 138 may circulate from rear duct 172 to top duct 174 (e.g., according to specific embodiments, input parameters, etc.). Top duct 174 may extend along the transverse direction T from a top of rear duct 172 toward a front of cooking chamber 14. In some embodiments, top duct 174 extends an entire length (e.g., along the transverse direction T) of cooking chamber 14. Additionally or alternatively, top duct 174 may extend along the lateral direction L. For instance, a width of top duct 174 along the lateral direction may be substantially a width of cooking chamber 14 along the lateral direction L.

The at least one exhaust outlet may include a top exhaust 179. Top exhaust 179 may be defined in the top duct 174. For instance, with brief reference to FIG. 4, top exhaust 179 may be provided at or near a bottom of top duct 174 (e.g., facing cooking chamber 14). Accordingly, air exhausted into cooking chamber from top duct 174 may be motivated in a downward direction (e.g., along the vertical direction V). Top exhaust 179 may include one or more openings or louvers extending predominantly along the transverse direction T. An extending length of top exhaust 179 may vary according to specific embodiments. For one example, the openings or louvers of top exhaust 179 extend between about 60% and about 80% of a total depth (e.g., along the transverse direction T) of top duct 174. Additionally or alternatively, the openings or louvers of top exhaust 179 may extend between about 60% and about 80% of a total width (e.g., along the lateral direction L) of top duct 174.

Referring now to FIG. 7, an exemplary selection process for initiating the joint cooking operation will be described. In detail, the user may select (e.g., via user interface assembly 62) the joint cooking operation. In the embodiment shown, the joint cooking operation is referred to as “Meal Cook,” however any suitable reference may be used to indicate performing a cooking operation on multiple items requiring different temperatures within cooking chamber 14. User interface assembly 62 (e.g., display 66) may present the user with an option to select a first temperature. The temperature options may be provided to the user in predetermined increments (e.g., 10 degree increments, 25 degree increments, etc.). Optionally, the user may enter a custom temperature for the first temperature.

The first temperature may be associated with a first heating zone or cooking zone (or, in some instances, a first food item). The first temperature may thus be a temperature at which the first cooking zone (e.g., and/or the first food item) must or should be cooked. The first temperature may be an average temperature that the first cooking item should be exposed to (e.g., within cooking chamber 14). As described, the first cooking item may be a food item, a cookware item, a bake item, or the like. For instance, the first temperature may be a set temperature within cooking chamber 14 (e.g., within first heating zone 152) at which the first cooking item should be heated.

The user may select a zone (e.g., a heating zone such as first heating zone 152, second heating zone 154, etc.) with which the first temperature will be associated. The user may be presented with a plurality of potential zones. As shown in FIG. 6, the zone options may include a top zone, a bottom zone, a left zone, a right zone, a front zone, or a back zone. Additional or alternative zones may be suggested, however, and the disclosure is not limited to the examples given herein. In some instances, a user may define a custom zone within cooking chamber 14.

The user may then select a second temperature and a second zone (e.g., either concurrently or separately). For instance, upon selecting the first temperature and the first zone, display 66 may present options for the second temperature and the second zone. The options for the second temperature may be limited and may be dependent on the first temperature. For instance, the possible selections for the second temperature may be limited to a range surrounding the first temperature. According to at least one example, if a user selects 350° F. for the first temperature, the options for the second temperature are limited to a range where 350° F. is the midpoint. The range may be a predetermined amount above and below the first temperature. For the example given above, the range may be between 300° F. and 400° F. The range may vary according to specific embodiments, however. Additionally or alternatively, upon selecting the first zone, cooking appliance 10 may automatically select the second zone to be complementary to the first zone. For example, if the top zone is selected as first heating zone 152, the bottom zone is automatically selected as the second heating zone 154.

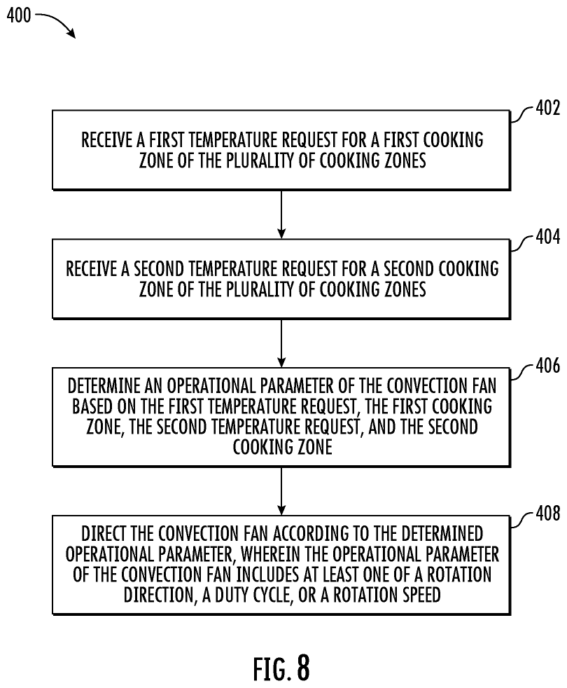

Now that the general descriptions of an exemplary appliance have been described in detail, a method 400 of operating an appliance (e.g., cooking appliance 10) will be described in detail. Although the discussion below refers to the exemplary method 400 of operating cooking appliance 10, one skilled in the art will appreciate that the exemplary method 400 is applicable to any suitable domestic appliance capable of performing a cooking operation (e.g., such as a cooktop appliance, a stand-alone oven, etc.). In exemplary embodiments, the various method steps as disclosed herein may be performed by controller 40 and/or a separate, dedicated controller. FIG. 8 provides a flow chart illustrating a method of operating a cooking appliance. Hereinafter, method 400 will be described with specific reference to FIG. 8.

At step 402, method 400 may include receiving a first temperature request for a first cooking (e.g., heating) zone of a plurality of cooking zones via the user interface. For instance, as described above, a user may initiate a cooking operation (e.g., a joint cooking operation) by selecting a first temperature at which a first item is to be cooked. The first temperature may be associated with a first cooking zone. The first cooking zone may be selected together with the first temperature, as mentioned above.

At step 404, method 400 may include receiving a second temperature request for a second cooking (e.g., heating) zone of the plurality of cooking zones via the user interface. In detail, the second cooking zone may be different from the first cooking zone. As described above, the first cooking zone may be the top zone within a cooking chamber (e.g., cooking chamber 14), while the second cooking zone is the bottom zone within the cooking chamber. Moreover, the second temperature request may be different from the first temperature request. For instance, the second temperature request may be higher or lower than the first temperature request (e.g., by a predetermined amount). As discussed above, the second temperature request may be bound by an upper limit and a lower limit with regard to the first temperature request.

At step 406, method 400 may include determining an operational parameter of the convection fan based on the first temperature request, the first cooking zone, the second temperature request, and the second cooking zone. In detail, upon receiving each of the inputs relating to the temperature requests and the cooking zones, the method 400 may determine the zone or zones which may require additional heat, additional heated air, or the like, as provided by the convection fan (e.g., convection fan 138). As mentioned above, the cooking chamber may be divided into two or more cooking (or heating) zones (e.g., front and back, top and bottom, left and right, etc.). Thus, the operational parameter of the convection fan may be determined to simulate or provide heat or remove heat from one of the identified zones.

Referring briefly to FIG. 3, the cooking appliance may circulate convection air (e.g., via the convection fan) through a pair of side exhaust outlets. The cooking chamber may be divided into two cooking zones including a left cooking zone (e.g., first heating zone 152) and a right cooking zone (e.g., second heating zone 154). According to at least one example using these zone inputs, the left cooking zone includes a higher temperature input request (e.g., 400° F.) than the right cooking zone (e.g., 350° F.). Step 406 may thus include determining that additional heat (or simulated heat via convection phenomenon) should be supplied to the left cooking zone. For instance, step 406 may be performed before an initiation of the cooking operation (e.g., before activating one or more heating elements). Additionally or alternatively, step 406 may be performed continually throughout the cooking operation. For example, a temperature of the cooking chamber (e.g., specifically at one or more of the designated cooking zones) may be monitored throughout the cooking operation (or cooking sequence) such that adjustments to heating elements or fans (e.g., convection fan, vent fan, etc.) can be made in real time.

For instance, the method 400 may determine a rotational direction of the convection fan. As mentioned above, the convection fan may be a variable speed, bi-directional fan (e.g., capable of rotating clockwise or counterclockwise). In the instance wherein the cooking chamber is divided into the right and left zones, the method 400 may initially determine which zone requests the higher temperature. Referring again to the example above, when the left cooking zone requests the higher temperature, the operational parameter of the convection fan may include a counterclockwise rotational direction. According to some implementations, setting the rotational direction of the convection fan to counterclockwise produces a higher airflow to the left cooking zone within the cooking chamber.

Further, in setting the rotational direction of the convection fan to counterclockwise and thus producing focused or increased airflow to the left cooking zone, the convection heating element may be set to be activated (e.g., driven) during the cooking operation. As would be understood, with increased airflow directed toward the left cooking zone due to the set rotational direction of the convection fan, when the convection heating element is activated, a higher temperature of air may be circulated and focused toward the left cooking zone. Accordingly, the left cooking zone (e.g., first heating zone 152) may simulate a higher temperature than the right cooking zone (e.g., second heating zone 154).

In additional or alternative embodiments, again referring to the example above, the rotational direction of the convection fan may be set to clockwise. Accordingly, airflow (e.g., convection airflow) may be focused toward the right cooking zone (e.g., second heating zone 154). In this instance, the convection heating element may be deactivated for the cooking operation. As the convection heating element is deactivated, the air circulation focused toward the right cooking zone may be comparatively cooler than the air circulated through the left cooking zone. Thus, the simulated temperature within the left cooking zone may be maintained higher than the simulated temperature within the right cooking zone. According to additional or alternative iterations or operational parameters, while the convection fan is rotated clockwise, the convection heating element may be activated. Accordingly, an increased amount or level of heat may be supplied to or through the right cooking zone. Thus, a combination of rotational direction of convection fan and an activation state (e.g., on, off) of convection heating element may increase or decrease heat to a specific lateral zone defined within the cooking chamber.

In still further additional or alternative embodiments, the convection fan may be initiated at a predetermined time with respect to the preheat phase. For instance, the convection heating operation may be initiated before the oven appliance finishes the preheating phase. According to this example, food items are positioned within the cooking chamber (e.g., within their respective zones) after a completion of the preheat phase. However, such an operation may take place with the food items positioned within the cooking chamber. Thus, the method 400 may transition the cooking operation from the preheat phase to the cook phase before the cooking chamber has reached the temperature request (e.g., first temperature or second temperature). Accordingly, cooking chamber air may be relatively cooler (e.g., as compared to after a completion of the preheat phase). Accordingly, upon activating the convection fan (e.g., in the clockwise direction), the relatively cooler air may be directed or urged over the food item(s) positioned in the right cooking zone. The convection fan may be driven immediately upon initiation of the cook phase, or may be delayed by a predetermined amount of time.

Moreover, once the oven appliance finishes the preheat phase and enters the cooking phase, the air supplied to the cooking zone (e.g., right cooking zone) may be relatively cooler than the air generally surrounding the food item(s) in the opposite cooking zone (e.g., left cooking zone). For instance, as the food item in the focused zone (e.g., the right cooking zone) is heated (e.g., by radiation from the cooking chamber walls), the relatively cooler convective air flow may reduce a total heat transfer within the focused zone, thus emulating a lower temperature within the focused zone. Additionally or alternatively, as the relatively cooler air is cyclically urged over the food item in the right cooking zone, the air may absorb heat (e.g., from the surface of the food item, from the cooking chamber walls, etc.). At a predetermined point (e.g., as dictated by a temperature sensor or inferred based on heater power level and time since initiation of the cooking phase), the convection heating operation may be reduced (e.g., a convection fan speed, a convection fan rotational direction, a convection heating element power level, etc.). For instance, a temperature of the convection air may be compared with a temperature of a surface of the first food item. The surface temperature of the first food item may be inferred (e.g., based on a total time within the cooking chamber and the first temperature request).

In another example, the cooking chamber is divided into a top zone and a bottom zone. Referring briefly to FIG. 2, the top zone may be the first heating zone while the bottom zone is the second heating zone. As can be seen in FIG. 2, the convection fan may be positioned immediately adjacent the bottom (e.g., second, or lower) cooking zone (e.g., along the transverse direction T). In the instance where the at least one exhaust outlet includes the pair of side exhaust outlets, the convection airflow from the convection fan may be focused toward the bottom zone.

According to this example, the bottom zone may be associated with the higher temperature input request. Thus, the convection heating element may be activated in addition to driving the convection fan. For instance, the method 400 may determine that the convection air flow temperature should be greater than the surface temperature of the food item provided in the bottom zone. In additional or alternative embodiments, the method 400 may determine that the bottom zone is associated with a lower temperature input request (e.g., lower than the top zone). The convection heating element may be deactivated while the convection fan is driven in this instance.

As another example, referring briefly to FIG. 4, the cooking chamber is divided into a front zone (e.g., first heating zone 152) and a rear zone (e.g., second heating zone 154). When the rear zone is designated as the high heat zone (i.e., the temperature input request for the rear zone is higher than the temperature input request for the front zone), the convection heating element may be activated while the convection fan is activated (e.g., during the cooking sequence). Accordingly, heated air is provided immediately to the rear zone. The rear zone may thus experience a higher simulated temperature than the front zone. Similarly, when the front zone is designated as the high heat zone (i.e., the temperature input request for the front zone is higher than the temperature input request for the rear zone), the convection heating element may be deactivated while the convection fan is activated (e.g., during the cooking sequence). Accordingly, non-heated air is provided immediately to the rear zone. The rear zone may thus experience a lower simulated temperature than the front zone.

As mentioned above, the duct may include a top duct provided along a top of the cooking chamber. According to some embodiments, air from the convection heating assembly may exhaust (e.g., into the cooking chamber) from the top duct (e.g., downward along the vertical direction V). For instance, the top duct may include a plurality of outlets through which air moves from the duct (e.g., top duct) into the cooking chamber. According to at least some embodiments, the plurality of outlets positioned near the front of the cooking chamber. Accordingly, air exhausted from the top duct may be focused toward the front cooking zone (e.g., when the cooking chamber is divided into the front cooking zone and rear cooking zone).

Since the air exhausted from the top duct may be focused more toward the front cooking zone, when the front cooking zone is associated with a higher temperature input, the convection fan and convection heating element may be activated to increase a flow of hot or heated air over the food item provided in the front cooking zone. According to another instance or operational parameter, the convection fan may be activated while the convection heating element remains deactivated (e.g., when the front cooking zone is identified as a lower temperature cooking zone).

Additionally or alternatively, the method 400 may determine a rotational speed of the convection fan or a duty cycle of the convection fan as one of the operational parameters. The rotational speed of the fan may be determined according to a particular heating zone that requires additional heat (e.g., in order to simulate the temperature input request). In some embodiments, the difference in temperature input requests between the different cooking zones may dictate a rotational speed of the convection fan (e.g., a higher temperature difference equates to a higher rotational speed). Similarly, the duty cycle of the convection fan (e.g., an on/off cycle of activation and deactivation) may be dictated by the difference in temperature input requests between the different cooking zones. Further still, an outlet duct of the convection air (e.g., side duct, top duct), may dictate a rotational speed or duty cycle of the convection fan. For instance, in a front cooking zone/rear cooking zone operation utilizing the top duct, a higher rotational fan speed may result in high air flows at the front cooking zone, while a lower rotational fan speed may result in higher air flows at the rear cooking zone.

Accordingly, determining the operational parameter of the convection fan may include estimating a temperature of the convection air at the at least one exhaust outlet (e.g., a first side exhaust outlet, a second side exhaust outlet, a top exhaust outlet, etc.). The estimated temperature of the convection air may then be compared to the temperature input request at each cooking zone. Thus, the operational parameter of the convection fan may be determined or adjusted according to the temperature comparisons. When the temperature of the convection air is higher than the temperature of the surface of the food item, the convection air from the convection fan may increase heating in the determined cooking zone. Consequently, when the temperature of the convection air is lower than the temperature of the surface of the food item, the convection air from the convection fan may decrease heating in the determined zone.

Additionally or alternatively, the method 400 may include determining one or more heating parameters (e.g., radiation heating patterns) of each of the bake heater (e.g., bottom heating element) and the broil heater (e.g., top heating element). For instance, upon determining the operational parameter of the convection fan (or prior to determining the operational parameter of the convection fan), heating patterns such as power levels, duty cycles, control constants, or the like may be determined for one or both of the bake heater and the broil heater. The heating pattern of one or both of the bake heater and broil heater may be determined together with or separately from the operational parameter of the convection fan. For example, a power level of the top broil heater can be determined according to the rotational direction of the convection fan (e.g., to increase the simulated heat level at the top heating zone).

Additionally or alternatively, the method 400 may include determining one or more attributes of a cookware item provided in the cooking chamber. For instance, a sensor (e.g., camera 159) may capture one or more images of the cooking chamber and transmit the captured image signal to the controller of the cooking appliance. In some instances, the sensor may provide a live feed image signal to the controller. The controller (or a separate off-board controller) may analyze the image and determine the one or more attributes of a cookware item provided in the cooking chamber. For instance, the image analysis may determine the presence of a first cookware item in the first heating zone and a second cookware item in the second heating zone. Further, the image analysis may determine a color, texture, reflectivity, material, size, shape, or other attribute of each cookware item. The cooking operation (e.g., the operational parameter of the convection fan) may be adjusted according to the determined attribute or attributes of the cookware item.

Additionally or alternatively, the method 400 may include determining a venting operation (e.g., via an ambient air inlet and a cooking chamber vent). As mentioned above, the cooking appliance may include a cooking chamber vent passageway (e.g., between the ambient air inlet and the cooking chamber vent). According to the first and second temperature input requests and the first and second cooking zones, the venting operation may be determined to selectively provide a flow of relatively cool air (e.g., as compared to air within the cooking chamber) to one or more of the cooking zones.

At step 408, method 400 may include directing the convection fan according to the determined operational parameter. As mentioned above, the operational parameter may include a rotational direction, a duty cycle, a rotation speed, etc. of the convection fan. Additionally or alternatively, step 408 may include directing the convection heating element (when present) according to the determined operational parameter (e.g., when heated air is required to be circulated). Further still, step 408 may include directing one or both of the bake heater and the broil heater according to the one or more determined heating patterns. Accordingly, the cooking operation may be performed with each heating element and the convection fan directed to simulate the requested temperature input requests. Advantageously, specific airflows as directed by the convection fan (in combination with activation or deactivation of particular heating elements) may simulate two distinct temperatures within a single cooking chamber, allowing multiple food items to be cooked simultaneously.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A cooking appliance defining a vertical direction, a lateral direction, and a transverse direction, the cooking appliance comprising:
a cabinet forming a cooking chamber, the cooking chamber defining a plurality of cooking zones therein;
a plurality of heating elements provided within the cooking chamber;
a duct system in fluid communication with the cooking chamber, the duct system defining an intake and at least one exhaust outlet;
a convection fan for motivating air between the cooking chamber and the duct system; and
a controller operably connected with the plurality of heating elements and the convection fan, the controller configured to perform a cooking operation, the cooking operation comprising:
receiving a first temperature request for a first cooking zone of the plurality of cooking zones;
receiving a second temperature request for a second cooking zone of the plurality of cooking zones;
determining an operational parameter of the convection fan based on the first temperature request, the first cooking zone, the second temperature request, and the second cooking zone; and
directing the convection fan according to the determined operational parameter, wherein the operational parameter of the convection fan comprises at least one of a rotation direction, a duty cycle, or a rotation speed.

2. The cooking appliance of claim 1, wherein the plurality of heating elements comprises a convection heating element provided adjacent to the convection fan.

3. The cooking appliance of claim 1, wherein the duct system comprises:
a rear duct provided at a rear of the cabinet along the transverse direction, the convection fan being provided in the rear duct.

4. The cooking appliance of claim 3, wherein the at least one exhaust outlet of the duct system comprises:
a pair of side exhaust outlets provided at lateral sides of the rear duct within the cooking chamber.

5. The cooking appliance of claim 3, wherein the duct system further comprises:
a top duct provided at a top of the cabinet along the vertical direction, and wherein the at least one exhaust outlet of the duct system comprises:
a top exhaust defined in the top duct within the cooking chamber.

6. The cooking appliance of claim 1, further comprising:
an ambient air inlet defined in the cabinet through which ambient air selectively enters the cooking chamber;
a cooking chamber vent defined in the cabinet; and
a cooling fan provided at the cooking chamber vent to selectively urge air within the cooking chamber to an ambient atmosphere.

7. The cooking appliance of claim 1, wherein the plurality of heating elements comprises:
a bake heater provided at a bottom of the cooking chamber; and
a broil heater provided at a top of the cooking chamber.

8. The cooking appliance of claim 7, wherein the cooking operation further comprises:
determining one or more heating parameters of each of the bake heater and the broil heater in response to receiving each of the first and second temperature requests; and
directing each of the bake heater and the broil heater according to the one or more determined heating parameters.

9. The cooking appliance of claim 1, further comprising:
a sensor provided within the cooking chamber, and wherein the cooking operation further comprises:
determining one or more attributes of a cookware item provided in the cooking chamber via the sensor; and
adjusting the determined operational parameter of the convection fan in response to determining the one or more attributes of the cookware item.

10. The cooking appliance of claim 9, wherein the sensor is a camera configured to capture a digital image of the cookware item.

11. The cooking appliance of claim 1, wherein determining the operational parameter of the convection fan comprises:
estimating a temperature of convection air at the at least one exhaust outlet; and
comparing the estimated temperature of the convection air at the at least one exhaust outlet with a temperature of a first food item within the first cooking zone, wherein the temperature of the first food item is a surface temperature of the first food item.

12. A method of operating a cooking appliance, the cooking appliance comprising a cooking chamber defining a plurality of cooking zones, a plurality of heating elements, a duct system in fluid communication with the cooking chamber and defining an intake and at least one exhaust outlet, and a convection fan for motivating air between the cooking chamber and the duct system, the method comprising:
receiving a first temperature request for a first cooking zone of the plurality of cooking zones;
receiving a second temperature request for a second cooking zone of the plurality of cooking zones;
determining an operational parameter of the convection fan based on the first temperature request, the first cooking zone, the second temperature request, and the second cooking zone; and
directing the convection fan according to the determined operational parameter, wherein the operational parameter of the convection fan comprises at least one of a rotation direction, a duty cycle, or a rotation speed.

13. The method of claim 12, wherein the plurality of heating elements comprises a convection heating element provided adjacent to the convection fan.

14. The method of claim 13, further comprising:
determining a convection heating pattern of the convection heating element based on each of the first and second temperature requests, the first and second cooking zones, and the operational parameter of the convection fan; and
directing the convection heating element according to the determined convection heating pattern.

15. The method of claim 12, wherein the plurality of heating elements comprises:
a bake heater provided at a bottom of the cooking chamber; and
a broil heater provided at a top of the cooking chamber.

16. The method of claim 15, further comprising:
determining one or more heating parameters of each of the bake heater and the broil heater in response to receiving each of the first and second temperature requests; and
directing each of the bake heater and the broil heater according to the one or more determined heating parameters.

17. The method of claim 12, wherein the cooking appliance further comprises a sensor provided within the cooking chamber, the method further comprising:
determining one or more attributes of a cookware item provided in the cooking chamber via the sensor; and
adjusting the determined operational parameter of the convection fan in response to determining the one or more attributes of the cookware item.

18. The method of claim 12, wherein determining the operational parameter of the convection fan comprises:
estimating a temperature of convection air at the at least one exhaust outlet; and
comparing the estimated temperature of the convection air at the at least one exhaust outlet with a temperature of a first food item within the first cooking zone, wherein the temperature of the first food item is a surface temperature of the first food item.

19. The method of claim 12, wherein the cooking appliance further comprises:
an ambient air inlet defined in a cabinet of the cooking appliance through which ambient air selectively enters the cooking chamber;
a cooking chamber vent defined in the cabinet; and
a cooling fan provided at the cooking chamber vent to selectively urge air within the cooking chamber to an ambient atmosphere.

20. The method of claim 19, further comprising:
directing the cooling fan based on the first temperature request, the first cooking zone, the second temperature request, and the second cooking zone.
